(19) United States
(12) Patent Application Publication
(10) Pub. No.: US 2007/0101264 A1
(43) Pub. Date: May 3, 2007

(54) Position-and length-sensitive video timeline behavior

(75) Inventors: Thamer A. Abanami, Seattle, WA (US); Brian King, Carnation, WA (US); Eric D. Eng, Kirkland, WA (US); Julian Leonhard Selman, Redmond, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/264,848

(22) Filed: Nov. 1, 2005

(51) Int. Cl. G11B 27/00

(52) U.S. Cl. 715/716; 715/723; 715/719

(57) ABSTRACT

Improved scanning of digital video programs is provided for by adjusting scanning rates according to the length of the video program and/or the length of the remaining portion of the video program to be scanned. Shorter video programs are scanned at a slower speed, and longer video programs at a faster speed. In alternate embodiments, scanning speed is based in part on the length of the portion of the video program remaining to be scanned. Thus, when scanning in a video program a forward direction (“fast forward”) when only a given amount of the program remains to be scanned, the scanning speed is slowed. The amount of the program may be determined either according to a fixed length or relative to the length of the entire program. Additionally, in some embodiments, different scanning techniques are used based on the length of the video program being scanned or the length of the video program portion remaining to be scanned.

### BACKGROUND

Video programs, such as movies, music videos, television programs, news clips, etc., are increasingly available in digital video form. Generally, digital video information includes frames of video information to be displayed sequentially at a specific rate and audio soundtrack information to be played along with the video information.

When using digital video data, a user in some cases does not want to view the entirety of the video contained in the video data. Rather, a user will at times wish to view the video not from the beginning of the video but from an intermediate point. Additionally, during the viewing of the video, the viewer may wish to find another portion of the video to view.

One way in which a viewer may select a starting point for viewing is by specifying a point in the video from which to start. For example, some video programs to view video data allow a user to decide that viewing should begin fifteen minutes from the beginning of the video program. Additionally, some video program allow for certain prespecified points in the video data which a user can use to specify where viewing should begin. For example, a video contained in video data is broken up into chapters with specific starting points. A user then chooses to begin viewing from a certain chapter starting point.

Additionally, some video programs to view video data store a viewer's previous history viewing the video data. Thus, a viewer can decide to begin to view the program at the point where viewing of the video had previously left off.

However, while these techniques allow a user to jump to a specific point in a video program, at times a user will want to determine a point to begin viewing by scanning the video. Such a scan plays the video at an increased speed for the user, either selecting only some frames of video information for display, or displaying each frame but displaying them more quickly than during regular viewing of the video. Scanning can be performed in a forward direction, in the same sequence as normal viewing, or a backwards (reverse) direction. This allows the user to visually locate a point in the video with certain content, and then to start normal playback of the video at this selected point.

Problems, however, arise with such scanning. If the scanning speed is too high, and the user is navigating a short video program, the user will hit the end too quickly and may be unable to find a relevant point in the video program to stop the scan. If the scanning speed is too low, it becomes cumbersome and time consuming to fast forward or scan through a longer video program.

Some video scanning techniques deal with the problem of low scanning speed by providing accelerated scanning—where a user has indicated they would like a scan by pressing a button (e.g. a “fast forward” or “reverse” button on a remote) the scan speed accelerates over time as long as the button continues to be depressed. However, when using such an accelerated scanning technique, often a user finds it difficult to visually process content near the end of the program (for forward scanning) where scanning is occurring at the fastest rate. Similarly, when reverse scanning is occurring often a user finds it difficult to visually process content near the beginning of the program where scanning is occurring at the fastest rate.

### SUMMARY

When scanning is occurring through a video program, according to some embodiments of the invention, the scanning speed is determined by the length of the video program. A length-based rate is set which is proportional to the length of the video program. This length-based rate is used as the scan rate. Thus, for a shorter video program, the scanning speed is low. For a longer video program, the scanning speed is high.

In other embodiments, the length-based rate is used in other ways to determine the scanning speed. For example, a modified accelerated scanning technique uses the length-based rate, by setting the scan rate using the length-based rate when the user indicates that scanning is desired and then increasing the scan rate if the user indicates that the scan rate should be increased, or if the user does not stop the scanning.

In some embodiments, a maximum or minimum scan rate is used along with the length-based rate so that the scanning speed is never faster than the maximum scan rate or slower than the minimum scan rate. In some embodiments, both a maximum and a minimum scan rate are used.

In some embodiments, the length of the video program is used to set the scan rate in other ways. For example, the length of the video program may be used to select between three possible starting scan rates. Video programs longer than a certain first length would use a fastest scan rate as the starting scan rate. Video programs shorter than a second length would use a slowest scan rate as the starting scan rate. And video programs shorter than the first length and longer than the second length would use an intermediate scan rate as the starting scan rate.

In some embodiments, the length of the video program is used to select between scanning algorithms. For example, in one embodiment accelerated scanning is used to scan longer video programs, while a constant speed scan is used to scan shorter video programs.

In some embodiments, scanning speed is based on the remaining length of the video program in the direction of scan. Thus, in one example, if only 10% of the video remains to be scanned in the direction of scan (if the last 10% of the video is about to be scanned in the forwards direction, or the first 10% of the video is about to be scanned in the reverse direction), the scanning speed is set to a prespecified scan rate for scanning the end of the video program (in the forwards direction) or the beginning of the video program (in the backwards direction). Alternately, the scan rate may be based on the absolute length of the remaining portion to be scanned. In such embodiments, when only one minute remains to be scanned, a slower scan rate is used.

Only some embodiments of the invention have been described in this summary. Other embodiments, advantages and novel features of the invention may become apparent from the following detailed description of the invention when considered in conjunction with the drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram of an exemplary computing environment in which aspects of the invention may be implemented;

FIG. 2 is a graphical representation of a timeline for a digital video program made up of in part of a sequence of images to be displayed in at a certain rate;

FIG. 3 is a graphical representation of a timeline with a deceleration interval for forward scanning according to one embodiment of the invention;

FIG. 4 is a flow diagram according to one embodiment of the invention; and

FIG. 5 is a flow diagram according to one embodiment of the invention.

### DETAILED DESCRIPTION OF ILLUSTRATIVE EMBODIMENTS

Exemplary Computing Environment

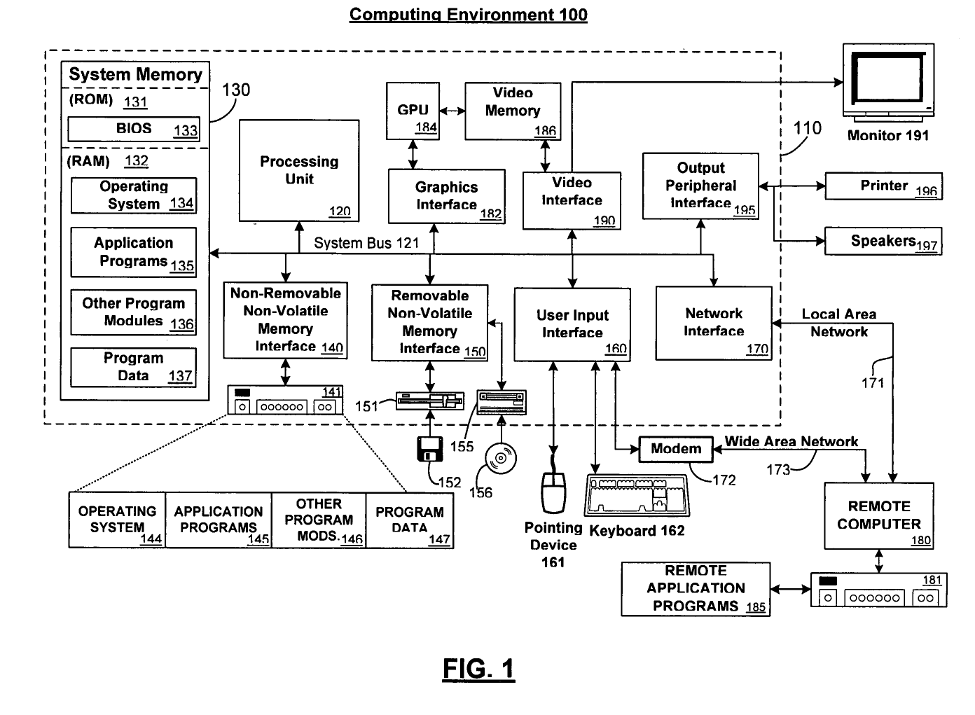

FIG. 1 shows an exemplary computing environment in which aspects of the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary computing environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, embedded systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The processing unit 120 may represent multiple logical processing units such as those supported on a multi-threaded processor. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus). The system bus 121 may also be implemented as a point-to-point connection, switching fabric, or the like, among the communicating devices.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Position- and Length-Sensitive Video Timeline Behavior

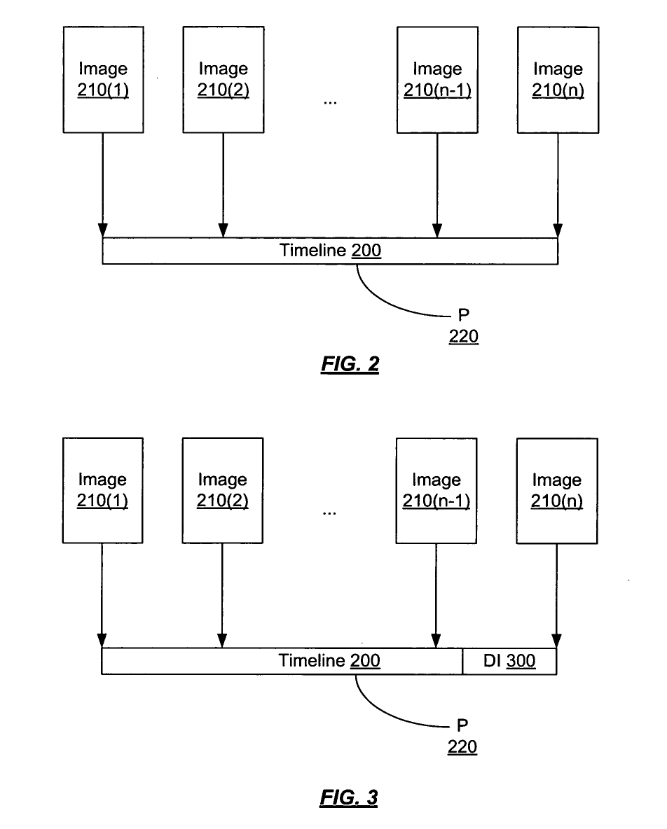

A digital video program generally includes a sequence of images which are intended to be displayed in at a certain rate, it can be considered as consisting of a timeline of images. FIG. 2 is a graphical representation of such a timeline. As shown in FIG. 2, timeline 200 includes images 210(1), 210(2) through 210(n-1), and 210(n). The images are arranged in a sequence, and the timeline sequence is chronological from the left side of the timeline 200 to the right side of the timeline 200. Thus, the digital video program is generally viewed by the viewer at a constant, predetermined rate with the images in the sequence shown in the timeline 200.

According to various embodiments of the invention, a portion of a video program is displayed at a scan rate on a display. With reference again to FIG. 1, the monitor 191 may be used for display and the computer 110 may be used for video program display control. However, the invention is not limited to a computing environment 100 as shown in FIG. 1. Any system including a display and a video program display control functioning according to the techniques described is encompassed. Additionally, the invention encompasses a system which processes video program data for display by a separate device according to the techniques described, and other systems which incorporate the techniques for setting a scan rate as described below, without limitation.

With reference again to FIG. 2, in one embodiment of the invention, in order to allow scanning of the video program, a faster scanning speed is used than the predetermined rate for normal viewing. Thus, for example, either all images 210 are displayed, but at a faster rate than the predetermined viewing rate. Alternately, during scanning, some of the images 210 are displayed, and others are not displayed. The images that are displayed are displayed in the sequence of timeline 200. The images which are displayed may be displayed at the predetermined viewing rate (or faster or slower) but the result, because only some images 210 are displayed, is generally that the portion of the timeline 200 for which images are viewed is scanned faster than that portion would be scanned if the timeline was being viewed at the normal viewing rate. This progress across a portion or all of the timeline is scanning, and the rate at which progress occurs through the timeline is the scanning speed. Scanning may occur in the same direction as viewing, fast-forwarding through the video program. Alternately, scanning may occur in the reverse direction, reversing (or “rewinding”) through the video program.

According to some embodiments of the present invention, the scanning speed is based on the total length of the video program. For example, in one embodiment of the invention, the scanning speed is based on the total length of the video program. Various ways exist for the scanning speed to be based on the total length of the video program. For example, the scanning speed may be directly related to the total length of the video program so that the scanning of the entire program takes a fixed period of time, for example, two minutes. In this example, if the video program were an hour long, the scanning speed would be thirty times the viewing speed. Scanning the entire program would thus take two minutes. If the video program were two hours long, the scanning speed would be sixty times the viewing speed, and scanning would still take two minutes. If the video program were five minutes long, the scanning speed would be two-and-a-half times the viewing speed.

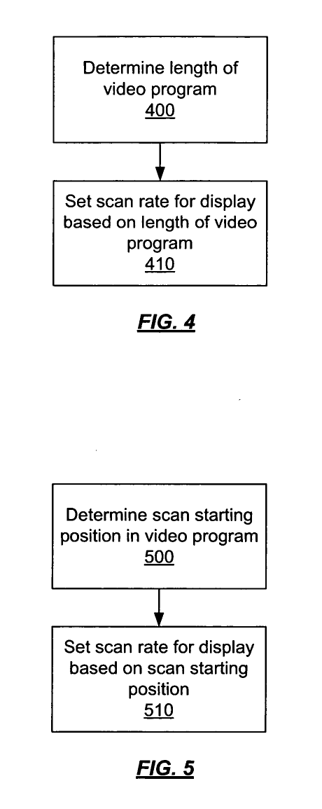

FIG. 4 is a flow diagram according to one embodiment of the invention. As shown in FIG. 4, step 400, first a determination is made of the length of the video program. In one embodiment, this determination is made by examining the video program data. In other embodiments, the determination is made by consulting metadata regarding the video program. For example, video program data may include both the images (and soundtrack, etc.) for display and a length value indicating the length of the video program. In some cases, the video program may be stored elsewhere and streamed on request to a system for display—in such cases, metadata indicating the length of the video program is made by consulting available metadata regarding the length of the video program or by making a determination in some way based on video program data.

In step 410, once the video program length has been determined, the video program is displayed at a scan rate. The scan rate is based on the length of the video program.

According to some embodiments, a certain number of preset scanning speeds to be assigned to a video program based on the length of the video program. For example, four scanning speeds S₁, S₂, S₃, and S₄ may be available and three thresholds T₁, T₂ and T₃ established. Video programs shorter than T₁ minutes long are scanned at speed S₁. Video programs longer than or equal to T₁ minutes long but shorter than T₂ minutes long are scanned at speed S₂. Video programs longer than or equal to T₂ minutes long but shorter than T₃ minutes long are scanned at speed S₃. Lastly, video programs longer than or equal to T₃ minutes long are scanned at speed S₄.

In addition to these, additional ways exist for the scanning speed to be based on the total length of the video program, and the invention is contemplated as encompassing these additional ways to base scanning speed on the length of the video program without limitation to these specific ways to base the scanning speed on the total length.

One refinement on such embodiments adds a minimum and/or a maximum scanning speed. According to embodiments with this refinement, scanning must occur at a rate equal to or faster than a minimum scanning rate and/or at a rate equal to or slower than a maximum scanning rate. Thus, returning to the above example embodiments where the scanning speed is set so that scanning of the entire program takes a fixed period of time (e.g. two minutes), a minimum scanning rate Rₘ is set, for example at two times the regular viewing speed. Thus, for a program which is three minutes long, the scanning rate would be calculated at one-and-a-half times regular viewing speed. However, since this is slower than the minimum scanning rate Rₘ, that minimum scanning rate is used. A maximum scanning rate R_{M} is established according to some embodiments—if a calculated scanning rate based on the length of the video program is more than this maximum scanning rate R_{M}, the maximum scanning rate R_{M} is used for scanning.

Modified Accelerated Scanning

In accelerated scanning, as described above, scanning does not occur at a constant rate. Rather, the scanning speed increases as time goes on as long as the user signals that scanning should continue, for example by continuing to depress a “fast forward” or “reverse” key. Alternately, scanning speed increases as time goes on if the user does not signal that scanning should stop, for example, by pressing a “stop” button.

According to some embodiments of the present invention, modified accelerated scanning is performed. In some embodiments, modified accelerated scanning is performed by setting the initial scanning rate using the length of the program, as described above. Once an initial scanning rate is set as described above, it increases over time until scanning is stopped. Alternately, the scanning rate according to the length of the video program may constitute a limit on the speed which can be attained during accelerated scanning. In such embodiments, the initial scanning rate is increased until the scanning rate calculated according to the length of the video is encountered. In some embodiments, scanning rate increases are also stopped when the user indicates that the scanning rate should remain constant, e.g. by depressing a button or by lifting a finger off a button which has been depressed.

According to one embodiment of the present invention, both the initial scanning rate and a maximum scanning rate are set based on the length of the video. For example, the scanning rate may be set so that initially, scanning is at a rate which would allow the entire video program to be scanned in four minutes, but that the scanning is accelerated until a rate is reached which would allow the entire video program to be scanned in two minutes. As described above, additional maximum and minimum scanning speeds can be applied to this embodiment, so that scanning is never slower than a minimum scanning rate Rₘ or faster than a maximum scanning rate R_{M}.

Position-Based Scanning

In some embodiments, the scanning rate is based, at least in part, on the length of the video program remaining to be scanned. Thus, with reference again to FIG. 2, if scanning is proceeding from a point P 220 in a forwards direction (towards image 210(n)), the scanning rate will be based on the length of the portion of the video program between point P 220 and the end of the timeline 200. If scanning is proceeding in reverse, then the scanning rate is based on the length of the portion of the video program between point P 220 and the start of the timeline 200.

FIG. 5 is a flow diagram according to one embodiment of the invention. As shown in FIG. 5, step 500, a determination is made regarding a scan starting position in the video program from which the display of said program will begin. In step 510, the video program is displayed starting from the scan starting position. The video program is displayed from that position at a scan rate which is based at least in part on the relative location of the scan start position in said video program.

In some embodiments, scanning speed is based on the remaining portion of the video program in the direction of scan. Thus, in one example, ten percent or less of the video program remains to be scanned in the direction of scan, one scanning speed is used, but if more than ten percent remains then a second scanning speed is used.

Thus, the scanning rate may be based on the relative length of the remaining portion video program to be scanned. Alternately, the scan rate may be based on the absolute length of the remaining portion to be scanned. For example, in one such embodiments, when only one minute of the video program (at normal viewing speed) remains to be scanned, a first scan rate is used, but when more than one minute of the video program remains to be scanned a second scanning rate is used.

In one embodiment, the scanning rate used when less of the video program remains is slower than the scanning rate when more of the video program remains. This allows the user more reaction time when the beginning or end of the program is being scanned.

Deceleration Interval

In some embodiments using a different scanning rate based on the portion of the video program remaining to be scanned, a deceleration interval is used. In such embodiments, a constant time interval is established as a “deceleration interval” at the beginning of playback for rewind and at the end of playback for fast forward. FIG. 3 is a graphical representation of a timeline with a deceleration interval for forward scanning. As shown in FIG. 3, a deceleration interval DI 300 is established. This deceleration interval DI 300 is at the end of the timeline, so that the end of the video program is established as a deceleration interval DI 300 for forward scanning. Other deceleration intervals may be established for reverse scanning or for other purposes. A different scanning policy is used inside of the deceleration interval DI 300 than is used outside of the deceleration interval DI 300. A scanning policy determines a scanning rate—some examples of scanning policies described above include: an absolute rate, a technique to determine a scanning rate, or any of these combined with a maximum or minimum scanning rate.

In one example, the policy outside of the deceleration interval DI 300 is the use of accelerated scanning. In this example, outside the deceleration interval DI 300, the scanning rate is adjusted upwards exponentially unless the user signals (by a positive or negative action—depressing a button or releasing a button) that the scanning rate should stop changing. If and when a maximum rate is reached, the scanning rate stays at that maximum rate. This combination of accelerated scanning and a maximum scan rate constitutes the policy outside of the deceleration interval DI 300.

In this example, the policy within the deceleration interval DI 300 is that the rate upon entering the deceleration interval DI 300 is attenuated linearly until it reaches the minimum scan rate. The combination of the two policies provides an overall scanning behavior which allows the user to control scanning and yet to receive the benefits of the accelerated scanning, the deceleration interval DI 300, and maximum and minimum scanning rate.

### Conclusion

It is noted that the foregoing examples have been provided merely for the purpose of explanation and are in no way to be construed as limiting of the present invention. While the invention has been described with reference to various embodiments, it is understood that the words which have been used herein are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

What is claimed:

1. A method for navigating a video program comprising:
determining the length of the video program; and
displaying a portion of said video program at a scan rate determined by a scan rate function, said scan rate function basing said scan rate at least in part on said length.

2. The method of claim 1 where said scan rate function selects a scan rate from among a plurality of possible scan rates based on said length.

3. The method of claim 1 where said scan rate selected by said scan rate is greater than or equal to by a predetermined minimum scan rate.

4. The method of claim 1, where said scan rate selected by said scan rate is less than or equal to by a predetermined maximum scan rate.

5. The method of claim 1, where said scan rate determined by said scan rate function varies over time, and where said display of said video program at a scan rate determined by said scan rate function displays said video program at said variable scan rate.

6. The method of claim 1, where said scan rate function bases said scan rate at least in part on data concerning actions of a user.

7. The method of claim 1, where said scan rate function bases said scan rate at least in part on which portion of said video program is being displayed.

8. A computer-readable medium comprising computer-executable instructions for displaying a video program, said video program comprising a sequence of at least two images, said computer-executable instructions for performing steps comprising:
determining a position in said video program where a display of said program will begin;
displaying said video program starting from said position at a scan rate, said scan rate based at least in part on the relative location of said position in said video program.

9. The computer-readable medium of claim 8, where a first scan rate is used if said position is before a reference location in said video program, and where a second scan rate is used if said position is after a reference location in said video program.

10. The computer-readable medium of claim 9, where said reference location is determined relative to the length of the video program.

11. The computer-readable medium of claim 9, where said video program contains an end position, where said reference location is determined based on the length of the portion of the video program between said reference location and said end position of said video program, and where scanning is proceeding in a forward direction.

12. The computer-readable medium of claim 9, where said video program contains a beginning position, where said reference location is determined based on the length of the portion of the video program between said reference location and said beginning of said video program, and where scanning is proceeding in a backwards direction.

13. The computer-readable medium of claim 8, where said scan rate decreases in a deceleration interval, where said deceleration interval comprises a portion of said video program which will be displayed last when displaying said video program based on the direction of display.

14. The computer-readable medium of claim 8, where said scan rate is based at least in part on data concerning actions of a user.

15. The computer-readable of claim 8, where said scan rate is based at least in part on a length of said video program.

16. A system for displaying a video program, said system comprising:
a display for displaying a portion of said video program;
a video program display control, operably connected to said display, said video program display control determining the length of the video program and displaying said portion of said video program at a scan rate basing at least in part on said length.

17. The system of claim 16, where said scan rate is based at least in part on user action data concerning actions of a user, said system further comprising:
a user input for receiving said user action data.

18. The system of claim 16, where said scan rate is based at least in part on which portion of said video program is being displayed.

19. The system of claim 18, where said scan rate decreases in a deceleration interval, where said deceleration interval comprises a portion of said video program which will be displayed last when displaying said video program based on the direction of display.

20. The system of claim 16, where said scan rate varies over time, and where said display displays said video program at said variable scan rate.
